(19) United States
(12) Patent Application Publication
(10) Pub. No.: US 2018/0148176 A1
(43) Pub. Date: May 31, 2018

(54) VEHICLE SEAT WITH A FLEXIBLE SHELL

(71) Applicant: STELIA AEROSPACE, Rochefort (FR)

(72) Inventor: Frédéric RODRIGUEZ, Rochefort (FR)

(21) Appl. No.: 15/716,970

(22) Filed: Sep. 27, 2017

(30) Foreign Application Priority Data
Sep. 28, 2016 (FR) 1659158

(51) Int. Cl. B64D 11/06; B64D 11/00

(52) U.S. Cl. CPC B64D 11/0606; B64D 11/00153; B64D 2011/0053; B64D 11/0639; B64D 11/00155; B64D 11/0624

(57) ABSTRACT

A seat includes a chair and a shell surround. The shell partially envelopes the chair and includes, a structural skeleton defining a meshed structure resulting from assembled members determining an overall shape in space of the shell, a set of finishing panels forming a skin covering the skeleton, the finishing panels being fixed to the skeleton to form the interior and exterior faces of the shell, and each finishing panel of the set covers at least one mesh of the meshed structure and bears on some or all of the members of the mesh or meshes that it covers.

### CROSS REFERENCE TO RELATED APPLICATIONS

This application claims priority from and the benefit of French Application No. 1659158, filed on 28 Sep. 2016, the disclosure of which is incorporated herein by reference in its entirety.

### BACKGROUND

### 1. Field

The presently disclosed embodiment belongs to the field of laying out the passenger spaces of vehicles and more particularly aircraft.

The presently disclosed embodiment concerns in particular vehicle seats including a shell surround intended to protect the mechanical parts of a seat mechanically and visually, and or to produce a private space effect for the occupier of the seat.

In the seat of the presently disclosed embodiment the structure of the shell surround is more particularly designed to enable late and modifiable customisation of the shell during manufacture and rapid and simple repairs of the shell.

### 2. Brief Description of Related Developments

In the field of passenger transport, in particular of aircraft, the seats offered to passengers are seen as fixtures and fittings having a strong commercial impact.

The airlines that operate the aircraft are therefore demanding not only in terms of comfort but also in terms of the visual effect and the aesthetics of the seats.

A seat, at least for classes offering an enhanced level of comfort like the seat 101 shown in FIG. 1, is a complex device in which the seat cushion 91, the seat back 92 and, when the seat includes them as shown, the headrest 93 and the footrest 94 are generally parts that are mobile relative to one another to impart to the seat different comfort positions.

In some cases a seat includes a shell 100 that generally covers the back of the seat and at least partly covers the lateral edges of the seat. The shell, which isolates the mechanical parts of the seat, decorates the seat and the cabin and procures for the passenger the comfort of a private space, in particular during rest periods.

The shell 100 therefore forms an essential and visible part of the seat, which is most often used to highlight the corporate colours of the airline and/or to provide decoration in harmony with the other fixtures and fittings of the cabin of the aircraft.

Moreover, for the same reasons damaged shells must be repaired or replaced quickly.

Current shells, such as for example the shell partly represented in FIG. 2, are produced in one piece so as to be rigid and self-supporting, most often in the form of a sandwich produced with its final shape so as to produce an assembly of stable shape under the conditions of use. They are produced with the required shapes and carry all the finishes, in particular colours, designs and raised patterns, for them to be integrated into the other parts of the seat to be installed in the cabin.

The complexity of these shells, for which non-developable shapes may be requested, in contrast to the shell example from FIG. 2 for the panel part, renders their manufacture difficult and necessitates a relatively long production cycle to take account of the design of the shell required by the aircraft operator, which design includes the shapes, colours and decorations and also the positions of the accessories made available to the passenger.

These necessary delays are often constraining and called into question if the required design is specified or modified late in the process of production of the seats and shell surrounds.

It is also possible for the design to be modified when the seats are already installed in a cabin at the instigation of an aircraft operator wishing to modify the ambience of the cabin or to change the latter if the aircraft has been taken over by another operator.

When the shells have been manufactured or are at an advanced stage of their production these changes or modifications of requirements lead to the necessity to manufacture new shells or at least to modify significantly the shells already produced if that is economically and technically acceptable.

The economic impact and the impact on production or modification cycles is then an important parameter.

Moreover in use the shell surrounds are exposed to stresses that can damage them, for example impacts from luggage or trolleys. In this case it is necessary to repair or to replace the shell to maintain safety and the good aesthetics of the cabin.

Current shell surrounds are therefore penalising because of their integral structures that are very difficult to modify during their production cycles and maintenance operations.

### SUMMARY

The presently disclosed embodiment provides a solution to the stated defects of the known solutions by proposing a seat including a chair and a shell surround. The shell includes an interior face on the side of the chair, i.e. the face of the shell that can be seen by an occupier of the seat, and an exterior face situated on an opposite face of the shell, the shell partially enveloping the chair.

Moreover, the shell includes:

a structural skeleton defining a meshed structure resulting from assembled members, each of the meshes of said meshed structure corresponding to a space of the skeleton without members materialised by peripheral members of said mesh. The skeleton determines in space an overall shape of the shell;

a set of finishing panels forming a skin covering the skeleton, the finishing panels being fixed to the skeleton to form the interior and exterior faces of the shell, and in which set of finishing panels each finishing panel:

covers at least one mesh;
bears on some or all of the members of the mesh or meshes that it covers.

It is therefore possible to produce a seat the shell of which is simple to produce, even with a shell surround with complex or non-developable shapes, without requiring complex production means and the mass of which is reduced because of the empty spaces in the meshes, whilst preserving a stiffness necessary for the environment of the cabin in which the seat is installed, for example a vehicle cabin such as an aircraft cabin.

In one aspect, a structure of at least some members of the skeleton is produced in a composite material forming hollow structural sections.

In one aspect, a structure of at least some members of the skeleton is produced in a cellular material, such as a foam, for example by a process of injection, stamping, rotary moulding or machining, said cellular material being reinforced by incorporation of mineral and/or organic and/or metal fibres.

In one aspect, a structure of at least some members of the skeleton is produced in a metal by forming structural sections or by machining.

Known materials and techniques can therefore be used, in combination or otherwise, for the production of the members in order to obtain the minimum weights and the robustness appropriate for the shells and in order to respect the constraints that can arise from a particular environment of use of the seat.

In one aspect, the skeleton includes reinforcements and/or attachment points and/or inserts for fixing accessories of the seat to the shell.

Whether one of the above features is used or not in the seat concerned, there is therefore used a skeleton that is complete in terms of capacity for installation of accessories so that the decision to provide an optional accessory on the seat can be taken late in the process of production of the seat and the optional accessory can also be added subsequently to a seat that does not have one without the skeleton of the shell surround being called into question.

In one aspect internal accessories are fixed to the skeleton of the shell inside a volume of said shell delimited by the skin formed by the finishing panels covering said skeleton. This exploits the hollow spaces of the meshes between the members to install optional or non-optional equipment, for example electronic control circuit cards necessary for the operation of equipment of the seat, for example electrical actuators for moving articulated parts of the seat, and for example circuit cards for communication with a network of the cabin in which the seat is installed.

In particular, the internal accessories fixed to the skeleton inside the volume of the shell belong to one of the following categories: “electrical devices, electrical wires or wiring harnesses, optical fibres or fibre bundles, air distribution ducts”.

In one aspect, external accessories are fixed to the skeleton of the shell so as to be accessible by an occupier of the seat or another seat near the seat. The skeleton in fact makes it possible to produce shells which, whilst remaining compact and of unitary construction when assembled, can at the design stage take into account the forces introduced into the structure of the shell by any type of seat accessories, in particular by the dimensions of the members and by the local reinforcements that may prove necessary, without this calling into question the general design principles of the shell surround.

In particular, the external accessories fixed to the skeleton belong to one of the following categories: “armrests, video screens, lights, headset sockets, seat movement remote controls, crew call interfaces, sensors”.

In one aspect, some or all of the finishing panels are fixed to the skeleton by reversible fixings allowing demounting of the finishing panels without damaging the finishing panels.

According to this aspect, the panels can be assembled late in the process of production of the seats without calling into question the other elements of the seat and the shell.

For example, some or all of the reversible fixings are press-studs. This exploits the ease and rapidity of mounting and demounting this type of fixing which moreover locates the panel and generally does not necessitate any specialised tools.

For example, some of all of the reversible fixings include a hot melt glue producing a weld or an adhesive bond between the skeleton and the skin. This results in secure fixings with little risk of accidental pulling off whilst remaining invisible on the exterior surfaces of the skin of the shell.

In this case, the skeleton advantageously includes, at least locally at locations at which panels are fixed to the skeleton, an element made from a ferromagnetic material that can be heated by magnetic induction. A ferromagnetic element of this kind can be formed by an insert in the skeleton so as to enable induction heating of the insert and melting of a material such as a hot melt glue that is heated when fixing or demounting a finishing panel by means of a tool including a coil generating a variable magnetic field.

The presently disclosed embodiment also concerns a family of seats according to the disclosed embodiment including at least two subfamilies.

The family is characterized by a skeleton design common to all the seats of the family.

A subfamily is characterized by a set of finishing panels of identical design for all the seats of the subfamily and of different design for the seats of other subfamilies.

There is therefore obtained a family in which the seats employ the same skeleton but for which different sets of finishing panels enable customisation of the seats of the family in different subfamilies.

In one aspect, the definition of a set of finishing panels includes for each of the finishing panels: the geometrical shapes and/or colours and/or decorations.

It is therefore possible to adapt the seats to shape and harmony requirements whilst remaining within the same family of seats.

In one aspect, the definition of a set of finishing panels is different according to whether the subfamily of seats concerned includes or does not include an optional accessory fixed to the shell.

### BRIEF DESCRIPTION OF THE DRAWINGS

The presently disclosed embodiment is described with reference to the figures, which are provided by way of nonlimiting example of one aspect of the presently disclosed embodiment and which show diagrammatically:

FIG. 1 (already cited) is an isometric view of an example of a known seat including a shell surround primarily forming a rear wall and lateral walls partially enveloping the seat;

FIG. 2 (already cited) is an isometric view of an example of a known shell surround element of developable shape, separated from the seat, shown in part and corresponding to one side and to part of the back of the shell of a known seat;

FIG. 3 is an isometric view of a seat according to the presently disclosed embodiment that includes a shell surround with a complex shape that is not developable and supports accessories of the seat;

FIG. 4 is an isometric view of a shell surround skeleton according to the presently disclosed embodiment showing the internal structure of the shell without the finishing panels. The detail (a) shows the skeleton in isometric view from behind and without the accessories shown in the main figure;

FIG. 5 is a partial exploded isometric view of a shell surround according to the presently disclosed embodiment and the principle of assembling finishing panels to the skeleton with the assistance of a robot;

FIG. 6 is an isometric view of a shell surround skeleton before mounting the finishing panels and showing the installation of an electrical wiring harness or optical cable bundle.

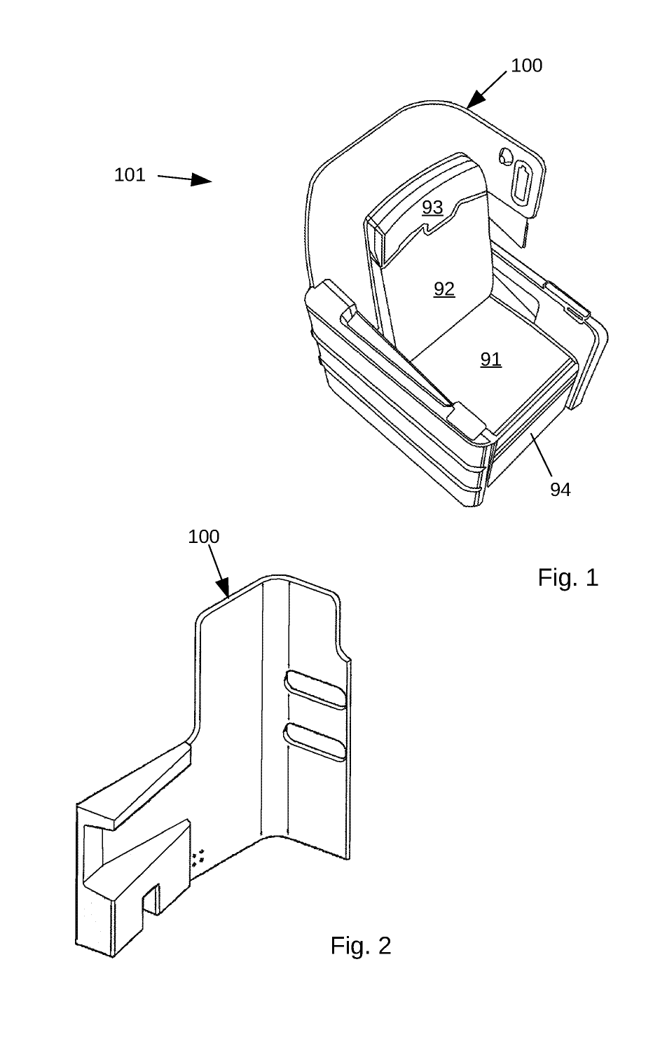

It should be noted that the various drawings are examples not necessarily representing parts of the same design of a seat or seat part.

In the various drawings, which may be to different scales, or in the same drawing, similar parts having the same function, even with different shapes, are identified by the same reference.

### DETAILED DESCRIPTION

FIG. 3 shows an example of a seat 101 according to the presently disclosed embodiment for an aircraft cabin represented by a floor 102 of the cabin to which said seat is fixed.

Here the seat 101 is shown on its own to clarify the illustration but it is naturally intended, at least in a conventional commercial aircraft cabin arrangement, to be associated with other seats, generally side by side and in successive rows.

For the purposes of the description the seat primarily includes a chair 90, a shell surround 100 and accessories 80.

In the conventional way, in the form shown, the chair 90 includes a seat cushion 91, a seat back 92, a headrest 93 and a leg rest 94, the latter two parts of the chair not being included in all seat designs. To adapt for the comfort of a passenger these various parts of the chair are generally mobile relative to one another through actions of the passenger, with or without electrical assistance.

There exist numerous known shapes and variants of seats of this kind. The design details of the chair of the seat of the presently disclosed embodiment are not the subject matter of the presently disclosed embodiment and the structure of the chair will not be described in more detail.

Nevertheless reference will be made hereinafter as and when required to the parts of the chair 90 when it is considered that these references are useful to clarify the description of the presently disclosed embodiment.

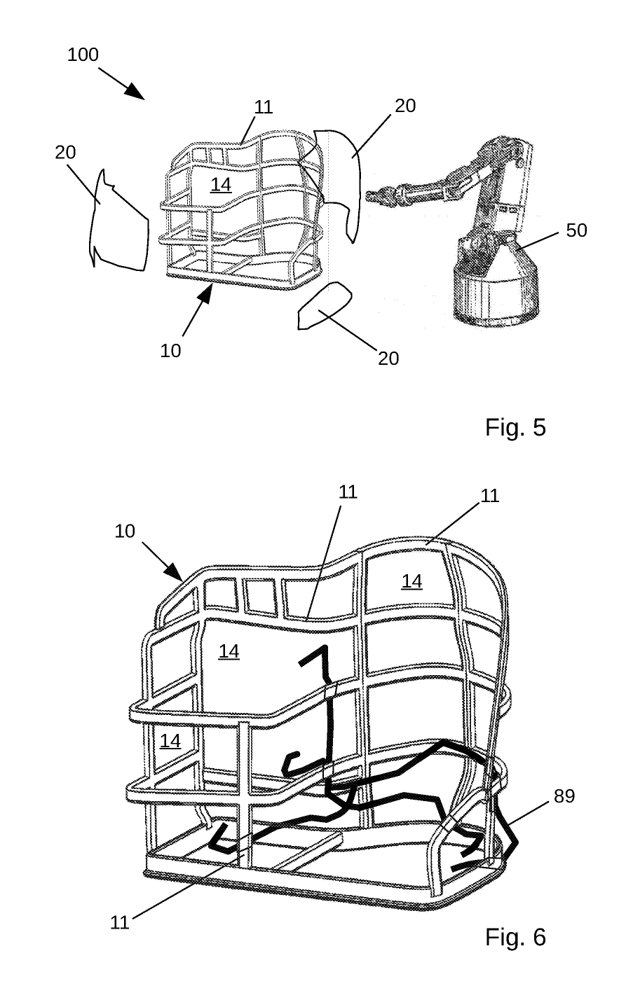

FIG. 5 is an exploded view of part of the structure of a shell surround 100 of an aircraft seat.

As shown in the figure, the structure of the shell surround 100 primarily includes a skeleton 10 and finishing panels 20. In FIG. 5 only a few finishing panels 20 from a set of finishing panels used for the shell are shown, detached from the skeleton 10.

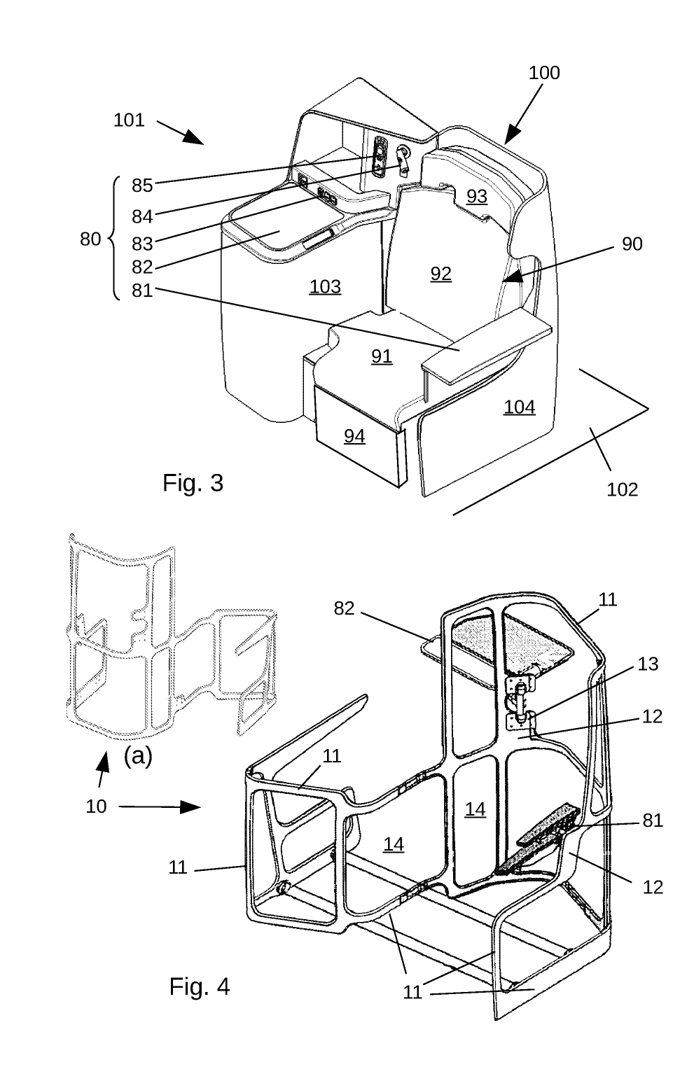

The skeleton 10, shown without finishing panels in FIG. 4, forms a rigid structural assembly the members 11 of which determine the general lines of the required shape of the shell surround 100.

The members 11 are more particularly shaped in accordance with constant lines for a family of shells that can have different finished shapes as will be clear from the remainder of the description.

The members 11 are rigidly interconnected to provide stability of the shape of the skeleton 10 and therefore constitute a spatial meshed structure that corresponds to an internal structure of the shell surround 100 and a structural mesh of said shell surround.

The members 11 of the skeleton 10 can be produced independently of one another and then assembled to constitute said skeleton.

Some or all of the members of a skeleton can equally be produced in one piece so that the number of assembly connections to obtain the skeleton is limited.

The members 11 are advantageously made from a composite material forming hollow structural sections, this structure producing a favourable strength to weight ratio for aeronautical applications.

The members 11 can equally be made from a cellular material such as a foam for example by a process of injection, stamping, rotary moulding or machining, the material being reinforced if necessary by incorporating mineral, organic or metal fibres.

The members 11 can also be produced by two composite half-skins glued or welded together to form a hollow, strong and lightweight structure.

The members can equally be made from metal, by forming structural sections or by machining.

It has to be understood here that the various techniques and the various materials described above are described by way of nonlimiting example and can be combined with one another to the degree that they are technically compatible with one another.

In practice the choice of materials and processes for the production of a member or a set of members will be guided, among other things, by the complexity of the shapes to be produced, by the loads that the structure formed by the skeleton has to withstand, by the number of shells of the same family that have to be manufactured and by the industrial tooling available for manufacturing the skeletons.

The skeleton 10 advantageously includes local reinforcements 12 and inserts 13 intended in the case of the former to withstand concentrated forces that have to be introduced into said skeleton and for the latter to form fixing points on the shell 100, in particular for certain accessories 80.

Most often the concentrated forces are associated with the accessories 80 and in this case inserts 13 for fixing said accessories are placed at the level of the corresponding local reinforcements 12.

The accessories 80 can have varied shapes and functions. One accessory is for example an armrest 81 for the occupier of the seat, a tray table 82, a video screen, or any other accessory at the discretion of the operator and having to be fixed to the shell surround of the seat.

Concentrated forces are generally also located at the level of the fixing points by which the shell is fixed to the seat or to a structure of the aircraft.

The concentrated forces can also correspond to particular locations on the shell 100, even in the absence of accessories and fixings, for example areas of the shell used as supports by a passenger when taking their seat or rising or areas subjected to exceptional forces, for example in the event of a crash corresponding to conditions defined by regulations.

In an advantageous aspect, the skeleton 10 is produced with all of the reinforcements and inserts necessary for an entire family of seats defined by skeletons 10 of identical shape, whether these reinforcements and inserts, at least when they are integrated into the structure of said skeleton, are used or not used for some seats of a subfamily of the family as a function of the options for the subfamily concerned.

Thus for example an insert used to fix an accessory present on the seats of one subfamily but absent from the seats of another subfamily will always be integrated into the skeleton of the same shape so that the same skeleton can be used interchangeably for the manufacture of seats belonging to one or the other of the two subfamilies.

The seats of a subfamily not including an optional accessory will moreover be easily convertible because of the presence of the inserts on the skeletons, without calling into question the skeleton 10 of the shell surround 100 of each seat in question.

As indicated, the shell surround 100 also includes finishing panels 20.

The finishing panels are shaped to be fixed to the skeleton 10 and produce a skin of the shell.

For reasons of the aesthetics of the seat, but also for maintenance and cleaning reasons, the shell surround 100 of a seat preferably includes finishing panels 20 on each of the faces of the skeleton 10. This arrangement defines within the thickness of the shell surround hollow volumes or meshes 14 between the members 11 at the edges of a mesh and the finishing panels 20 covering said meshes on the interior face 103 and the exterior face 104 of the shell 100.

By convention, the interior face 103 of the shell corresponds to the wall situated on the side of the seat 90, i.e. the face of the shell that is seen by an occupier of the seat. The exterior face 104 of the shell is the face opposite the interior face 103.

The distance separating the interior face from the exterior face at a location on the shell and normal to the surface at the location concerned therefore corresponds to a thickness of the shell at said location.

The thickness of the structure 100 can be adapted at any point of said shell by adapting the dimensions of the members in the direction of the thickness whilst employing finishing panels of substantially constant thickness, a priori relatively thin panels.

One face of the skeleton can include one or more finishing panels.

The choice of the number of finishing panels 20 depends in particular on the complexity of the shapes of the shell surround 100 and the dimensions of said shell surround, but a finishing panel 20 covers at least one mesh 14 of the mesh structure formed by the skeleton 10.

A finishing panel 20 will advantageously be designed to cover a plurality of meshes 14 of the meshed structure formed by the skeleton 10 in order to limit the numbers of finishing panels and connections between panels. However, the dimensions of a finishing panel will be limited to one mesh or to a small number of meshes if said panel has a shape that is complex to produce, being difficult to combine with its production in a panel of large size, or will potentially be required to be demounted frequently during the service life of the seat. This latter situation is encountered in practice for finishing panels situated at locations where the risks of damaging said panels, and therefore the necessity to repair or to replace them, are relatively high, or if said panels also serve as inspection hatches, notably for inspection or maintenance operations.

The visible shape of the shell 100 is therefore that which results from assembling the finishing panels 20 onto the skeleton 10.

Primarily for reasons of stability and of finishing panel retention, a finishing panel 20 advantageously bears on all the members 11 of the meshes 14 of the meshed structure formed by the skeleton 10 that it covers.

The shape of a finishing panel 20 and its spatial position linked to a frame of reference of the shell surround 100 are therefore constrained by the shapes and positions of the members 11 of the skeleton 10. However, provided that this constraint is complied with, the shape of a finishing panel 20 is free and can therefore be chosen by the designer of said finishing panel as a function of particular technical or aesthetic requirements.

Accordingly, a finishing panel 20 could have, between the members 11, a visible surface that is more or less flat, more or less curved, concave or convex, or have particular shapes such as trays for pocket contents.

It should be noted that different shapes may be necessary to provide the best match to the chairs 90 of the seats for which the shell 100 is intended, for example in the case of chairs including options such as a headrest 93 or particular cushions.

A finishing panel 20 could also include or not openings for the placing of fixings, in particular at the locations of the inserts of the skeleton 10 and intended for fixing optional accessories, for example a support. The finishing panels will then not include the opening for placing a fixing except in the case of shell surrounds 100 including the option concerned. This avoids providing on the shell surrounds that do not include the option a plug or a cover that can be lost or accidentally removed in use.

In this case, shells 100 including identical skeletons 10 belong to the same family of shell surrounds but belong to different subfamilies if they include different sets of finishing panels, conferring different appearances on them, for example.

The finishing panels 20 are fixed to the skeleton 10 by any appropriate means for retaining during use said finishing panels on said skeleton.

The fixings (not shown) will advantageously be chosen to allow demounting of the finishing panels 20 without damaging said finishing panels.

The fixing means will advantageously be chosen so as not to be visible or not very visible on the surface of the shell surround 100.

The fixing means can consist of conventional mechanical fixings such as screws or captive nut and bolt systems termed quarter-turn systems. In this case the skeleton will carry an insert nut into which the screw will be tightened. Although generally visible, this type of fixing means is suitable for retaining a finishing panel that has to be frequently demounted and refitted.

The fixing means can equally employ nesting mechanical fixings of the clip type.

The fixing means can equally employ combinations of self-gripping fabrics, for example Velcro® tape, suitable for retaining light panels.

The fixing means can also employ a glue that can be reactivated by induction. In this case the skeleton includes for example inserts made of a ferromagnetic material covered with a hot melt glue that can be heated by magnetic induction through the wall formed by said finishing panel when fixing or removing a finishing panel.

Finishing panels 20 can be fitted to or removed from a skeleton 10 manually or by a robot 50 including effectors adapted to pick, place and fix the finishing panels.

The finishing panels 20 are made in known manner of a thin material compared to the thickness of the shell 100 of which it forms the skin, with the required dimensions and shapes.

The panels are advantageously made from a thermoformable material, for example a polycarbonate or a thermoplastic matrix composite material, which enables the production of complex shapes by thermoforming on a mould, in particular shapes that cannot be developed.

The panels can equally be made from thermoset matrix composite materials, a resin polymerised by curing.

In one aspect, the finishing panels are formed in a thin skin decorated by a thermally applied film.

Most often the seats 101, at least in upper class, are provided with equipment fixed to the chair 90 or to the shell surround 100 that has to be connected to electrical wiring or optical cables. Such equipment includes for example video screens, lights 84, headset sockets 83, remote controllers 85 for the movements of the seat, crew call interfaces, sensors; this list is not exhaustive.

In one aspect the corresponding wiring will be fitted in the form of the wiring harness 89 shown in FIG. 6 during installation in the shell surround 100, advantageously between the finishing panels 20 situated on the opposite faces of said shell surround.

The shell of the seat of the presently disclosed embodiment here again proves particularly advantageous by allowing easy installation and mechanically protecting the wires of the wiring harness in an enclosed space, making these wires totally invisible in the cabin in which the seat is installed but, by virtue of the demountable finishing panels, allowing easy access for maintenance operations such as changing the wiring harness, repairing or replacing a wire, adding a wire following an evolution in the design of the seat.

At the production stage, the customised finishing panels can be mounted late in the process of industrial manufacture of the shell, and thereby reduce the manufacturing cycles, allowing the operator a later choice of decor and other options they require to be applied to their seats.

In use, the demountable finishing panels make it possible to change the decoration of a cabin simply by replacing panels without calling into question the skeleton 10, the operative part of the shell surround 100, which change can be carried out in the maintenance workshops of the operator.

The manufacture of a shell includes the following main steps:
selection of a skeleton 10 for the family of shell surrounds to which the seat for which the shell surround 100 is intended belongs;
fitting finishing panels 20 corresponding to the subfamily to which the seat for which the shell surround is intended belongs;
where applicable, at least before fitting finishing panels that would rule out the fitting of equipment into the shell surround, installing equipment in the shell surround corresponding to the options of the subfamily to which the seat for which the shell surround is intended belongs;
where applicable, at least before fitting finishing panels that would rule out fitting a wiring harness, fitting the wiring harness corresponding to the options of the subfamily to which the seat for which the shell surround is intended belongs;
fitting external accessories 80 fixed to the shell surround of the family and those corresponding to the options of the subfamily to which the seat for which the shell surround is intended belongs.

It should be noted that this last step can be carried out completely or partly when the shell surround and the chair are assembled, whether by necessity or for convenience.

What is claimed is:

1. A seat including a chair and a shell surround, said shell including an interior face on the side of said chair and an exterior face situated on an opposite face of said shell, said shell partially enveloping the chair, where the shell includes:
a structural skeleton defining a meshed structure resulting from assembled members, each of the meshes of said meshed structure corresponding to a space of the skeleton without members materialised by peripheral members of said mesh and determining in space an overall shape of the shell;
a set of finishing panels forming a skin covering the skeleton, said finishing panels being fixed to said skeleton to form the interior and exterior faces of the shell, and in which set of finishing panels each finishing panel:
covers at least one mesh;
bears on some or all of the members of the mesh or meshes that it covers.

2. The seat according to claim 1, in which a structure of at least some members of the skeleton is produced in a composite material forming hollow structural sections.

3. The seat according to claim 1, in which a structure of at least some members of the skeleton is produced in a cellular material, such as a foam, for example by a process of injection, stamping, rotary moulding or machining, said cellular material being reinforced by incorporation of mineral and/or organic and/or metal fibres.

4. The seat according to claim 1, in which a structure of at least some members of the skeleton is produced in a metal by forming structural sections or by machining.

5. The seat according to claim 1, in which the skeleton includes reinforcements and/or attachment points and/or inserts for fixing accessories of the seat to the shell.

6. The seat according to claim 1, in which internal accessories are fixed to the skeleton of the shell inside a volume of said shell delimited by the skin formed by the finishing panels covering said skeleton.

7. The seat according to claim 6, in which the internal accessories fixed to the skeleton inside the volume of the shell belong to one of the following categories: electrical devices, electrical wires or wiring harnesses, optical fibres or fibre bundles, and air distribution ducts.

8. The seat according to claim 1, in which external accessories are fixed to the skeleton of the shell so as to be accessible by an occupier of said seat or of another seat near said seat.

9. The seat according to claim 8, in which the external accessories fixed to the skeleton belong to one of the following categories: armrests, video screens, lights, headset sockets, seat movement remote controls, crew call interfaces, and sensors.

10. The seat according to claim 1, in which some or all of the finishing panels are fixed to the skeleton by reversible fixings allowing demounting of said finishing panels without damaging said finishing panels.

11. The seat according to claim 10, in which some or all of the reversible fixings are press-studs.

12. The seat according to claim 10, in which some of all of the reversible fixings include a hot melt glue producing a weld or an adhesive bond between the skeleton and the skin.

13. The seat according to claim 12, in which the skeleton includes, at least locally at locations at which panels are fixed to the skeleton, an element made from a ferromagnetic material that can be heated by magnetic induction.

14. A family of seats according to claim 1, including at least two subfamilies, said family being characterized by a skeleton design common to all the seats of the family and a subfamily comprising a set of finishing panels of identical design for all the seats of the subfamily and of different design for the seats of other subfamilies.

15. The family of seats according to claim 14, in which the definition of a set of finishing panels includes for each of the finishing panels: the geometrical shapes and/or the colours and/or the decorations.

16. The family of seats according to claim 15, in which the definition of a set of finishing panels is different according to whether the subfamily of seats concerned includes or does not include an optional accessory fixed to the shell.
